(19) United States
(12) Patent Application Publication
(10) Pub. No.: US 2019/0075814 A1
(43) Pub. Date: Mar. 14, 2019

(54) Method and Apparatus for Producing Flash Frozen Confections

(71) Applicant: Kenneth Bobbs, Lafayette, LA (US)

(72) Inventor: Kenneth Bobbs, Lafayette, LA (US)

(21) Appl. No.: 16/122,818

(22) Filed: Sep. 5, 2018

Related U.S. Application Data
(60) Provisional application No. 62/554,075, filed on Sep. 5, 2017.

(51) Int. Cl. A23G 9/06; A23G 9/22

(52) U.S. Cl. CPC A23G 9/06; A23G 9/22

(57) ABSTRACT

A method and apparatus for producing customized ice cream and ice cream-like confections that includes providing a liquid mixture of product, providing a bowl or wok and/or pan like freezing surface, providing a cryogenic storage vessel holding a quantity of cryogenic liquid, and directing a spray of cryogenic liquid onto the surface to provide a supercooled freezing surface. A quantity of the liquid confection mixture is the poured on the supercooled pan or bowl surface to flash freeze the mixture. The flash frozen product may then be transferred to a serving container and directly distributed to a consumer. The apparatus may also be provided with means for heating the freezing surface to facilitate transferring the flash frozen mixture of product to a serving container.

### PRIORITY

This application claims priority to U.S. provisional application Ser. No. 62/554,075 filed Sep. 5, 2017 entitled “Method and Apparatus for Producing Flash Frozen Confections”, the entire content of which is hereby incorporated by reference.

### FIELD OF THE INVENTION

This invention relates generally to the field of producing ice cream and ice cream-like confections, and more particularly relates to a method and apparatus for providing made to order instant customized ice cream and ice-cream like confections.

### BACKGROUND OF THE INVENTION

The present invention relates to a method and apparatus for producing customized ice cream and ice-cream like confections to consumers while they wait. The method and apparatus allows consumers to select the flavors and style of the ice cream and ice-cream like confections Which are then immediately prepared and frozen in the presence of the consumer.

### SUMMARY OF THE INVENTION

The presented invention provides a method and apparatus for producing customized ice cream and ice-cream like confections, including but not limited to ice cream, ice cream alternatives, yogurt, custard, Italian ice, slushies, and frozen or semi-frozen alcoholic mixtures. The apparatus includes a freezer pan having a flat, metal, upper pan surface; a lower plate affixed under the pan, in certain embodiments providing structures for heating and cooling the upper pan; a storage vessel holding a quantity of cryogenic liquid; supply lines and a nozzle for dispensing cryogenic liquid onto the surface of and to the underside of the upper pan; and a heat source for heating the freezer pan.

A customized ice cream or ice-cream like confection is created by first preparing a mixture of products such as cream, cream alternatives, alcohol, milk, sugar, thickeners, and flavorings such as chocolate syrup, to which may be added condiments such as chocolate chunks, fruit, or nuts.

When the confection mixture is ready, a quantity of cryogenic liquid is dispensed onto the surface of the upper pan and into the cavity between the upper pan and lower plate, to super-cool the upper pan. Next, the confection mixture is poured unto the pan upper surface where it is rapidly frozen due to the temperature of the supercooled pan upper surface. Then, the upper pan is heated to warm the pan upper surface to release the frozen confection mixture of product.

An alternate embodiment of the present invention includes a concave stainless steel freezing surface, such as that of a wok and/or paella pan; a lower sink basin containing a warming line which allows warm liquid, air, or steam into a warming manifold that directs the liquid, air, or steam onto the lower surface of the concave stainless steel freezing surface warming the lower surface of the concave stainless steel freezing surface; a storage vessel holding a quantity of cryogenic liquid; supply lines and a nozzle for dispensing cryogenic liquid onto the upper surface of the concave stainless steel freezing surface; and a heat source for heating the concave stainless steel freezing surface. In use a quantity of cryogenic liquid is dispensed onto the upper surface of the concave stainless steel freezing surface to super-cool the upper surface prior to adding confection mixture. Next, the confection mixture is poured unto the upper surface of the concave stainless steel freezing surface where it is rapidly frozen due to the temperature of the supercooled upper surface. Then the confection mixture may be stirred by rotating the concave stainless steel freezing surface in a counter rotational direction then that of the spatula or similar tool. Then, warming liquid, air, or steam is directed onto the lower surface of concave stainless steel freezing surface to warm the concave stainless steel freezing surface and release the frozen mixture of product.

When so prepared by both embodiments, the frozen product can be quickly prepared, heated to the point of release, scooped up by a spatula or similar tool or rolled or worked to a desired configuration such as a cigar or ball shape, and then placed into a container for serving.

### DESCRIPTION OF THE DRAWINGS

FIG. 1 is a schematic view of the apparatus for providing made to order instant customized ice cream and ice-cream like confections in accordance with the description set forth herein.

FIG. 1A is a schematic view of an alternate embodiment of the apparatus shown in FIG. 1.

FIGS. 2 through 8 show schematic views of the method steps for providing made to order instant customized ice cream confections in accordance the apparatus shown in FIG. 1.

FIGS. 9-11 show schematic views of another alternative embodiment of the apparatus shown in FIG. 1.

### DESCRIPTION OF THE EMBODIMENTS

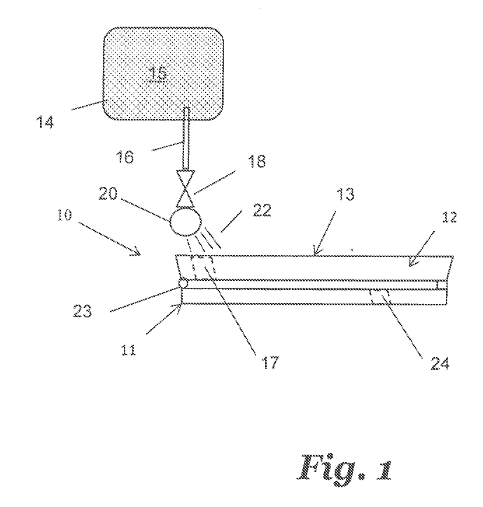

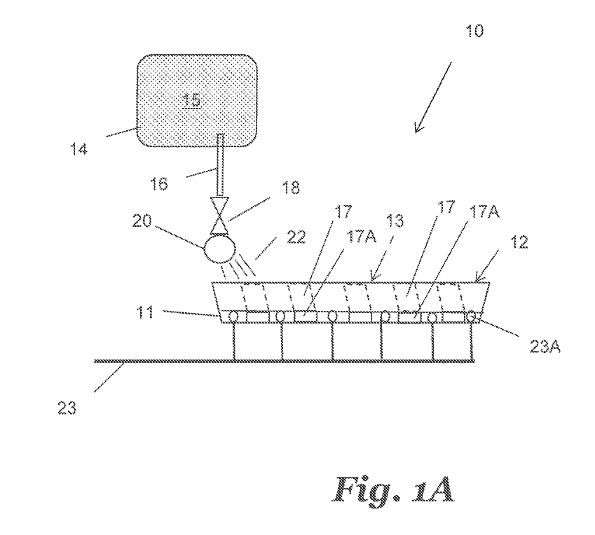

Referring now to the drawings, and particularly to FIG. 1 which shows an embodiment of the apparatus 10 for providing made to order instant customized ice cream and ice-cream like confections: The apparatus 10 is comprised of a flat, metal, with a freezing vessel 12 having an upper pan freezer surface 13 and a lower plate 11 separated from upper pan freezer surface 13 by a cavity 19, a storage vessel 14 holding a quantity of cryogenic liquid 15, cryogenic liquid supply lines 16, a cryogenic liquid control valve 18, and a cryogenic liquid nozzle 20 for dispensing a spray of cryogenic liquid 15 onto the upper pan freezer surface 13 and through one or more channels 17 communicating through freezing vessel 12 from upper pan freezer surface 13 to the cavity 19 between upper pan freezer surface 13 and lower plate 11. The cryogenic liquid may be any suitable liquefied gas such as liquid air or liquid nitrogen.

The apparatus 10 further incorporates warm-liquid line 23 and drain 24, which together comprise a heat source to heat freezing surface 12, easing the removal of the now-frozen confection mixture from upper pan freezer surface 13 after cryogenic liquid 15 has evaporated out of the cavity between freezing vessel 12 and lower plate 11 through channels 17. Water, steam, or another suitable heated liquid or gas may he fed from steam container 25 by articulation of steam control valve 26, wherein the heated liquid or steam will pass through line 23 and allowed to exit nozzle 30. After expulsion through nozzle 30, the projected heated liquid or condensed gas may drain through drain 24. Recirculation of the collected water or a suitable liquid may then flow in a closed loop between line 23 and drain 24 with an intervening apparatus (not shown) to add heat to the liquid.

The heat source of apparatus 10 also may include, rather than or in addition to warm-liquid line 23 and drain 24, heat-exchange channels 23A incorporated into lower plate 11 to circulate warm liquid within lower plate 11 to speed evaporation of cryogenic liquid 15 and speed heating of freezing surface 12. In such an embodiment, shown in FIG. 1A, without any cavity 19 between surface 12 and lower plate 11, lower plate 11 may be affixed flush to the underside of freezing vessel 12 with channels 17 feeding cryogenic liquid 15 into depression channels 17A incorporated into lower plate 11, preferably alternating with the aforesaid heat-exchange channels through which warm liquid flows. Freezing vessel 12 and lower plate 11 may also comprise a single structure employing one or more of the above heating and cooling strategies. The heat source of apparatus 10 may also include coils or rows of steam supply lines incorporated with freezing vessel 12 or may incorporate electric heating means incorporated with freezing surface 12.

The freezing vessel 12 of apparatus 10 will be preferably made of a steel alloy susceptible of withstanding extreme variations in heat and cold without cracking or warping. One such steel alloy thought to be suitable for freezing vessel 12 is 304/304 stainless steel produced by AK Steel Corporation of West Chester, Ohio.

As shown in FIG. 2, a customized ice cream or ice-cream like confection is created by first preparing a liquid mixture of ice cream or ice-cream like product 40 in a suitable pitcher or container 42. The mixture of product may include cream, cream alternative, alcohol, milk, yogurt, sugar, thickeners, and additional flavorings such as chocolate syrup or fruit syrup, and may include additional condiments such as chocolate chunks, fruit, or nuts.

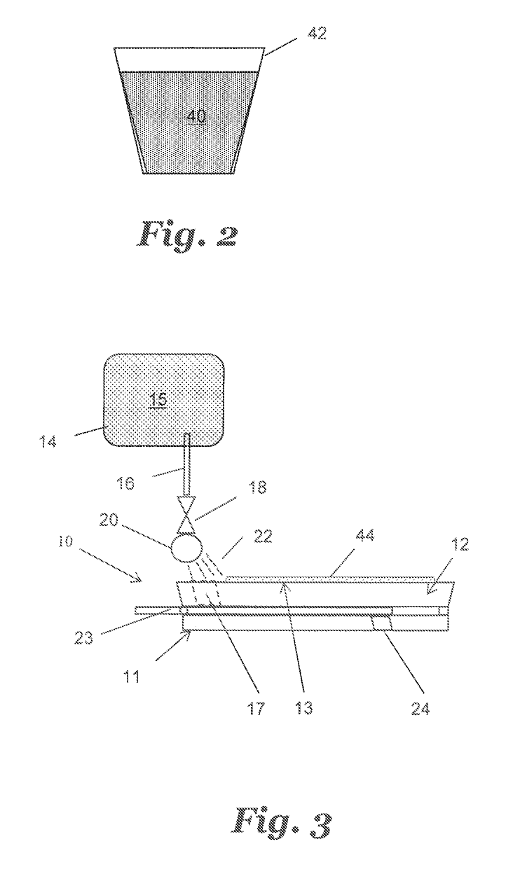

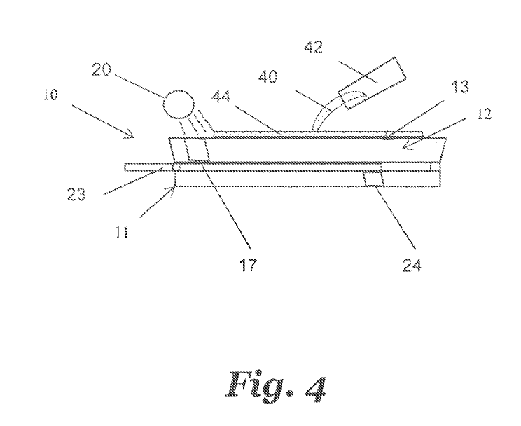

The freezing vessel 12 is then supercooled by opening cryogenic liquid control valve 18 and dispensing a spray of cryogenic liquid 15 through cryogenic liquid supply lines 16 and cryogenic liquid nozzle 20 onto the upper surface 13 of freezing vessel 12 and through channels 17 into the cavity 19 between freezing vessel 12 and lower plate 11 as shown in FIG. 3. Then, as shown in FIG. 4, the mixture of ice cream or ice cream-like product 40 is poured from container 42 onto the upper surface 13 of freezing vessel 12 where it is flash frozen on the upper surface 13 of freezing vessel 12 to create a layer of confection 44. Additional cryogenic liquid 15 may be dispensed from nozzle 20 onto the mixture and into channels 17 to achieve the desired temperature and consistency of the mixture, after which cryogenic liquid control valve 18 is closed.

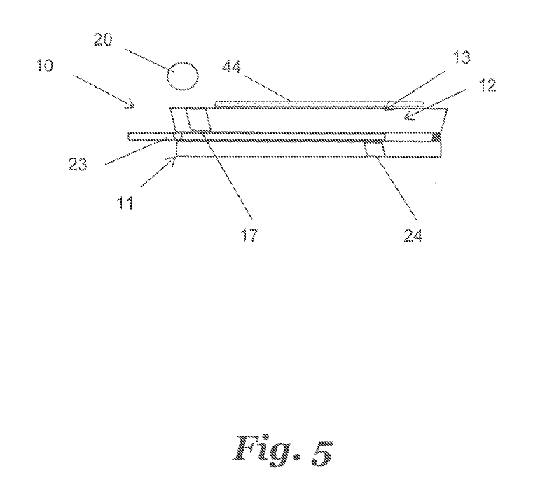

The freezing vessel 12 is then heated to release the layer of ice cream or ice cream-like confection 44 from the upper surface 13 of freezing surface 12. As shown in FIG. 5, the upper surface 13 of freezing vessel 12 is heated to release the layer of confection 44 from the surface 13 of freezing vessel 12 by opening warm-liquid line 23 to allow the flow of warming liquid underneath freezing surface 12, heating it, before exiting through drain 24. In other embodiments, other heating methods such as steam spray or steam-feed lines, electric heating, or closed-loop warm-liquid cooling may be used either to introduce heat to the underside of freezing vessel 12 or to heat freezing vessel 12 directly as discussed above.

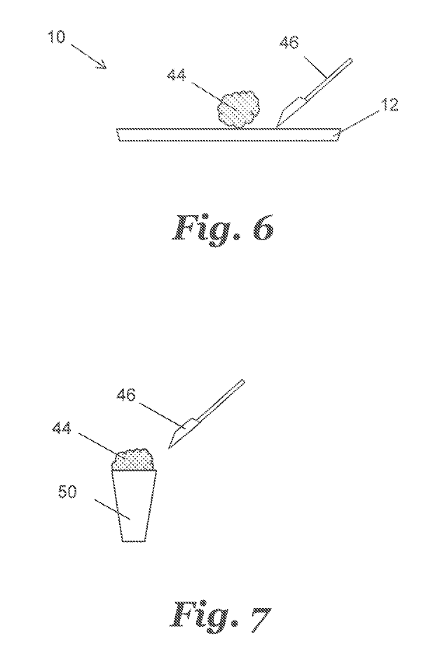

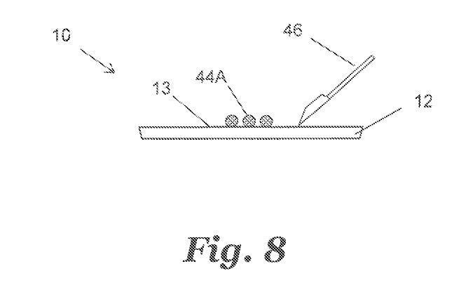

As the confection 44 is released from the heated upper surface 13 of the freezing surface 12, the confection 44 may be scoped up by a spatula, spoon, or similar tool 46 as shown in FIG. 6 and placed into a desired container 50 such as a howl or cone for serving as shown in FIG. 7. When so released, the confection 44 may also be worked as desired to create a confection of a desired shape such as a cylindrical eggroll-shaped confection 44A shown in FIG. 8.

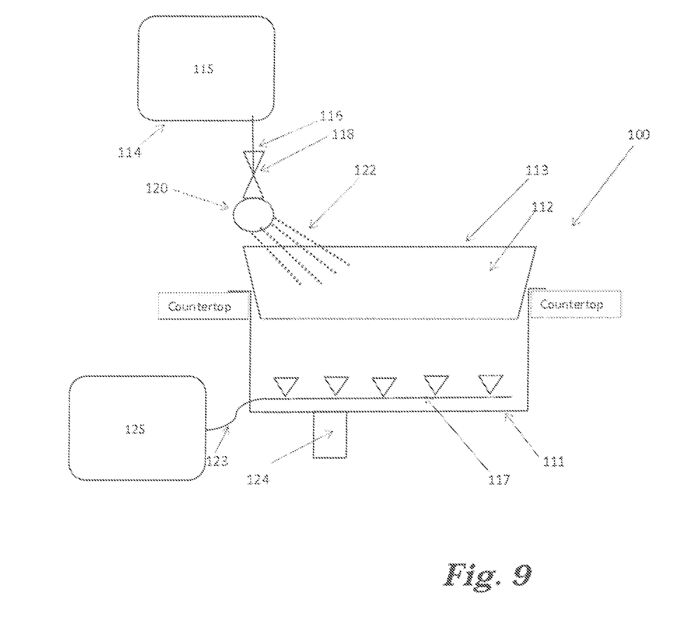

Referring now to FIGS. 9-11, an alternate embodiment of the apparatus 10 for providing made to order instant customized ice cream and ice-cream like confections is shown. The alternate embodiment is shown as apparatus 100 which is comprised of a concave freezing vessel 112, similar to that of a wok and/or paella pan, with an upper surface 113, a sink basin 111 in which concave freezing vessel 112 rests, a storage vessel 114 holding a quantity of cryogenic liquid 115, cryogenic liquid supply lines 116, a cryogenic liquid control valve 118, and a cryogenic liquid nozzle 120 for dispensing a spray of cryogenic liquid 115 onto the upper surface 113 of the concave freezing vessel 112. The cryogenic liquid may be any suitable liquefied gas such as liquid air or liquid nitrogen. The apparatus 100 further incorporates warming line 123, warming manifold 117, and drain 124, which together comprise a heat source to heat concave freezing vessel 112, easing the removal of the now-frozen confection mixture from upper surface 113. Similar to that of the freezing vessel 12 of apparatus 10, concave freezing vessel 112 of apparatus 100 will be preferably made of a steel alloy susceptible of withstanding extreme variations in heat and cold without cracking or warping such as that of 304/304 stainless steel.

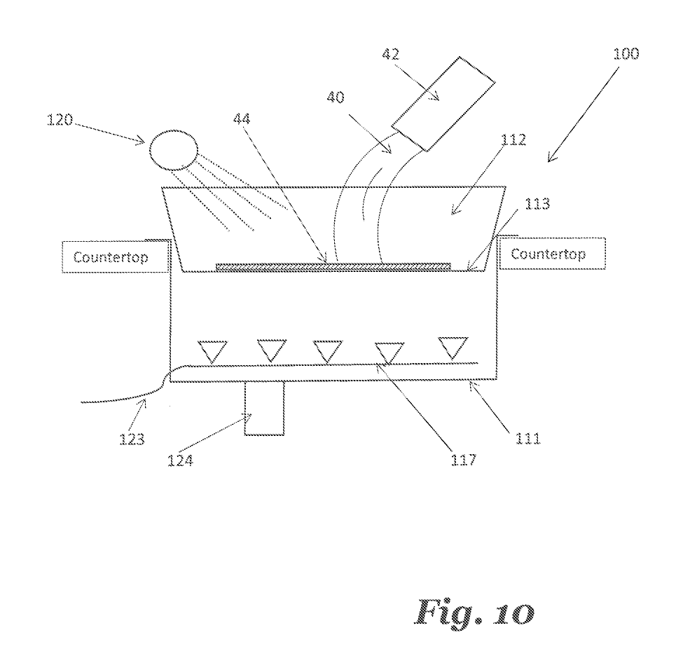

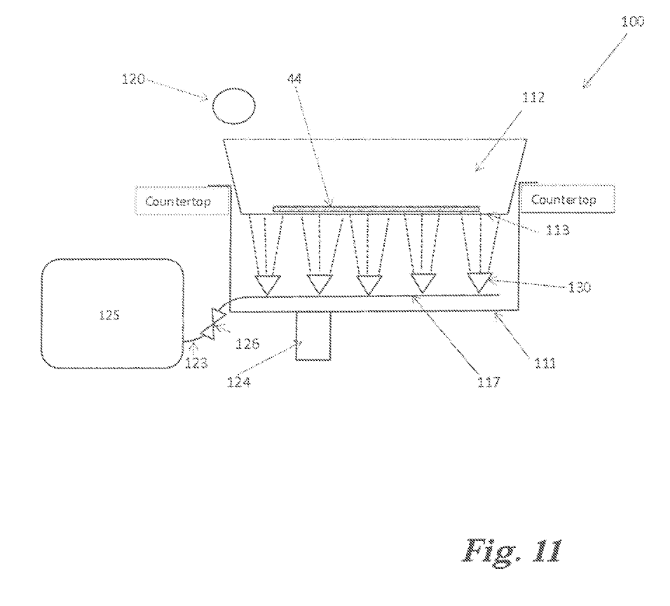

In use, the upper surface 113 of concave freezing vessel 112 is supercooled by opening cryogenic liquid control valve 118 and dispensing a spray of cryogenic liquid 115 through cryogenic liquid supply lines 116 and cryogenic liquid nozzle 120 onto the upper surface 113 of concave freezing surface 112. Then, as shown FIG. 10, the mixture of ice cream or ice cream-like product 40 is poured from container 42 onto the upper surface 113 of concave freezing vessel 112 where it is flash frozen on the upper surface 113 of concave freezing vessel 112 to create a layer of confection 44. Additional cryogenic liquid 115 may be dispensed from nozzle 120 onto the mixture to achieve the desired temperature and consistency of the mixture, after which cryogenic liquid control valve 118 is closed. The mixture may be stirred by rotating the concave freezing vessel 112 in a counter rotational direction then that of the spatula or similar tool 46.

The concave freezing vessel 112 is then heated to release the layer of ice cream or ice cream-like confection 44 from the upper surface 113 of concave freezing surface 112. In the embodiment shown in FIG. 11, the upper surface 113 of concave freezing vessel 112 is heated to release the layer of confection 44 from the upper surface 113 of concave freezing vessel 112 by opening warming line 123 by steam control valve 126 allowing liquid, air, or steam to pass from steam container 125 through warming line 123 and into the warming manifold 117 where it is then directed out of nozzle 130 under the concave freezing surface 112, heating it from beneath, before exiting through drain 124. Alternatively, other heating methods such as steam spray or steam-feed lines, electric heating, or closed-loop warm-liquid cooling may be used either to introduce heat to the concave freezing vessel 112 or to heat upper surface 113 directly as discussed above.

As the confection 44 is released from the heated upper surface 113 of the concave freezing surface 112, the confection 44 may be can be scoped up by a spatula, spoon, or similar tool 46 as shown in FIG. 11 and placed into a desired container 50 such as a bowl or cone for serving such as shown in FIG. 7. When so released, the confection 44 may also be worked as desired to create a confection of a desired shape such as a cylindrical eggroll-shaped confection 44A as shown in FIG. 6.

It is also thought that apparatuses 10 and 100 will be provided with safety mechanisms such as shielding devices and relief valves to protect the operator of the equipment from the extreme cold and heat produced by the apparatus. It is also thought that the operator will be provided with safety equipment such as gloves and protective glasses to prevent injuries.

It will be evident that various other changes may be made in the form, construction and arrangement of the parts and steps of the method and apparatus for producing customized ice cream confections described herein without departing from the spirit, scope, and material advantages of the invention. It is also thought that the method and apparatus for producing customized ice cream and ice cream-like confections presented herein will be understood from the foregoing description and that the forms and steps described herein are intended to be merely exemplary embodiments of the invention.

I claim:

1. An apparatus for producing customized ice cream and ice cream-like confections comprising:
(a) a freezing vessel having an upper freezer surface and a lower surface;
(b) a cryogenic storage vessel holding a quantity of cryogenic liquid;
(c) a cryogenic liquid nozzle directed to said upper freezer surface of said freezing vessel;
(d) a cryogenic liquid supply line from said cryogenic storage vessel to said cryogenic liquid nozzle;
(e) a cryogenic liquid control valve; and
(f) a means for heating said lower surface of said freezing vessel.

2. The apparatus recited in claim 1, further comprising:
(a) a steam storage vessel holding a quantity of steam;
(b) a steam supply line in communication between said steam storage vessel and a steam nozzle for directing steam to said lower plate;
(c) a steam control valve, wherein articulation of said steam control valve will direct steam from said steam storage vessel through said steam supply line and out said steam nozzle to direct said steam to said lower plate whereby said upper freezer pan surface may he heated,

3. The apparatus recited in claim 1, wherein said freezing vessel comprises:
(a) a flat metal freezer pan, said freezer pan having an upper pan freezer surface and a lower plate affixed to the underside of said upper pan freezer surface, said upper pan freezer surface and said lower plate creating a cavity under said upper pan freezer surface;
(b) at least one channel creating a passage through said upper pan freezer surface to said cavity; and
(c) wherein said cryogenic liquid nozzle is directed at said upper pan freezer surface and said channel through said upper pan freezer surface.

4. The apparatus recited in claim 2, wherein;
(a) said steam supply line is a warm-liquid line directing warm liquid to said cavity between said upper pan freezer surface and said lower plate; and
(b) a drain permitting exit of said warm liquid from said cavity.

5. The apparatus recited in claim 1, further comprising:
(a) one or more coils or rows of substantially horizontal warm-liquid channels incorporated into said upper pan freezer surface; and
(b) a warm-liquid line directed to said one or more coils or rows of warm-liquid channels; and
(c) a drain permitting exit of liquid.

6. The apparatus recited in claim 5, wherein said drain permits recirculation and re-heating of liquid.

7. The apparatus recited in claim 1, wherein said freezing vessel comprises a concave freezing vessel having an upper surface and a lower resting within a sink basin, wherein said means for heating said concave freezing surface includes a warming line in communication with a warming manifold.

8. The apparatus recited in claim 7, further comprising:
(a) a steam storage vessel holding a quantity of steam;
(b) a steam supply line in communication between said steam storage vessel and a steam nozzle for directing steam beneath said concave freezing vessel; and
(c) a steam control valve, wherein articulation of said steam control valve will direct steam from said steam storage vessel through said steam supply line.

9. A method for producing customized ice cream and ice cream-like confections comprising the steps of:
(a) providing a freezing vessel having an upper and a lower surface;
(b) providing a cryogenic storage vessel holding a quantity of cryogenic liquid;
(c) providing a liquid confection mixture of ice cream or ice-cream like product;
(d) directing said cryogenic liquid onto said upper surface of said freezing vessel whereby said upper surface of said freezing vessel is supercooled;
(f) pouring a quantity of said liquid confection mixture onto said upper surface of said freezing vessel thereby flash freezing said confection mixture;
(g) heating said freezing vessel; and
(h) transferring said flash frozen confection mixture to a serving container.

10. The method for producing customized ice cream and ice cream-like confections as recited in claim 9 wherein said step of heating said freezing vessel includes the additional steps of:
(a) providing a steam storage vessel holding a quantity of steam; and
(b) directing said steam to said lower surface of said freezing vessel.

11. The method for producing customized ice cream and ice cream-like confections as recited in claim 9 wherein said step of heating said freezing vessel includes the additional steps of:
(a) providing a warm-liquid line directing a warm liquid to a warming manifold;
(h) directing said warm liquid from said manifold to said lower surface of said freezing vessel: and (c) providing a drain permitting exit and collection of said warm liquid directed from said manifold.

12. The method for producing customized ice cream and ice cream-like confections recited in claim 9, wherein said quantity of cryogenic liquid includes liquid air or liquid nitrogen.

13. The method for producing customized ice cream and ice cream-like confections recited is claim 9, wherein said step of providing a liquid confection mixture comprises are selected from the group comprising cream, milk, yogurt, custard, sugar, water, alcohol, and thickeners.

14. The method for producing customized ice cream and ice cream-like confections recited in claim 9, including the step of providing additional condiments selected from the group comprising chocolate chunks, fruit, and nuts.

15. An apparatus for producing customized ice cream and ice cream-like confections comprising:
(a) a concave metal freezing vessel set within a sink or basin, said concave metal freezing vessel having an upper and lower surface, wherein said concave metal freezing vessel is positioned to freely rotate within said sink or basin;
(b) a cryogenic liquid nozzle positioned above said upper surface of said concave metal freezing vessel;
(c) a cryogenic storage vessel in communication with said cryogenic liquid nozzle by a cryogenic supply line, said cryogenic storage vessel holding a quantity of cryogenic liquid;
(e) a cryogenic liquid control valve connected to said cryogenic liquid supply line for direction of cryogenic fluid to said upper surface of said concave metal freezing vessel;
(f) a steam nozzle positioned below said lower surface of said concave metal freezing vessel;
(g) a steam storage vessel holding a quantity of steam, said steam storage vessel in communication with said steam nozzle by a steam supply line, and
(h) a steam control valve, whereby said steam control valve will direct steam from said steam storage vessel through said steam supply line and out said steam nozzle to direct said steam to said lower surface of said concave freezing vessel.
